(19) United States
(12) Patent Application Publication
(10) Pub. No.: US 2024/0238997 A1
(43) Pub. Date: Jul. 18, 2024

(54) CUTTING APPARATUS, CLEANING DEVICE, CLEANING BASE STATION, CLEANING SYSTEM, AND METHOD

(71) Applicants: JIANGSU MIDEA CLEANING APPLIANCES CO., LTD., SUZHOU (CN); MIDEA GROUP CO., LTD., FOSHAN (CN)

(72) Inventors: Hui GUO, SUZHOU (CN); Fuping CHENG, SUZHOU (CN)

(21) Appl. No.: 18/565,086

(22) PCT Filed: Sep. 15, 2022
(86) PCT No.: PCT/CN2022/118976

§ 371 Date: Nov. 29, 2023

(30) Foreign Application Priority Data
Sep. 16, 2021 (CN) 202111088166.X
Sep. 17, 2021 (CN) 202111093854.5
Sep. 17, 2021 (CN) 202111095162.4

(51) Int. Cl. B26B 19/06; A47L 11/24; A47L 11/40

(52) U.S. Cl. CPC B26B 19/06; A47L 11/24; A47L 11/40

(57) ABSTRACT

Provided are a cutting apparatus, a cleaning device, a cleaning base station, a cleaning system, and a method. The cutting apparatus includes a housing, N groups of blades, and a drive mechanism. The housing has an opening. N groups of blades each include a fixed blade and a movable blade. N fixed blades are located in the housing and arranged linearly. N movable blades are located in the housing and arranged linearly. Each of the N movable blades corresponds to one of the N fixed blades. Each of the N fixed blades and each of the N movable blades have a toothed edge protruding from the opening towards an outer side of the housing, and the toothed edge of the fixed blade is tightly fitted to the toothed edge of the movable blade.

### CROSS-REFERENCES TO RELATED APPLICATIONS

The present disclosure is a national phase application of International Application No. PCT/CN2022/118976, filed on Sep. 15, 2022, which claims priorities to Chinese Patent Application No. 202111095162.4 filed on Sep. 17, 2021, Chinese Patent Application No. 202111088166.X filed on Sep. 16, 2021, and Chinese Patent Application No. 202111093854.5 filed on Sep. 17, 2021, the entire disclosure of which are incorporated herein by reference.

### FIELD

The present disclosure relates to the field of cleaning appliances, and more particularly, to a cutting apparatus, a cleaning device, a cleaning base station, a cleaning system, and a method.

### BACKGROUND

This section provides only background information related to the present disclosure, which is not necessarily the prior art.

Nowadays, more and more cleaning devices like vacuum cleaners are entering people's homes. The main working component of a vacuum cleaner cleaning head is a rotary roller brush, which is in contact with the floor and beats and brushes away the dust. However, hair and other long fibrous debris easily get tangled on the roller brush, affecting a cleaning effect of the roller brush and making it difficult to clean. A cutter (movable cutter or fixed cutter) of an existing cleaning device is a whole long cutter with a quite high actual processing and fabricating cost. Additionally, the long cutter has a long blade, making it challenging to maintain straightness, which affects efficiency of cutting hair.

### SUMMARY

A main purpose of the present disclosure is to provide a cutting apparatus, a cleaning device, a cleaning base station, a cleaning system, and a method, aiming to solve at least one of problems described above.

To achieve the above purpose, the present disclosure provides a cutting apparatus, including: a housing having an opening; N groups of blades each including a fixed blade and a movable blade, and N fixed blades are located in the housing and arranged linearly, where N is a positive integer greater than or equal to 2; and N movable blades are located in the housing and arranged linearly, each of the N movable blades corresponding to one of the N fixed blades, each of the N fixed blades and each of the N movable blades having a toothed edge protruding from the opening towards an outer side of the housing, and the toothed edge of the fixed blade being tightly fitted to the toothed edge of the movable blade; and a drive mechanism in a linkage engagement with the movable blade and configured to drive a reciprocation of the movable blade relative to the fixed blade between a first position and a second position. At least two movable blades have movement directions opposite to each other.

The present disclosure also provides a cleaning device, including: a casing; a brush head; and the cutting apparatus as described above. The toothed edge of the fixed blade or the toothed edge of the movable blade is in contact with an outer peripheral surface of the brush head.

The present disclosure also provides a method for controlling cutting of hair by using the cleaning device as described above, the method includes: determining that the cleaning device is performing a cleaning operation, and controlling starting of the cutting apparatus; or determining that the cleaning device is performing the cleaning operation, and controlling the cutting apparatus to start intermittently; or determining that the cleaning device has completed the cleaning operation, and controlling the starting of the cutting apparatus.

The present disclosure also provides a cleaning base station, including: a base; and the cutting apparatus as described above, the cutting apparatus is mounted on the base. The toothed edge of the fixed blade or the toothed edge of the movable blade is in contact with an outer peripheral surface of a brush head.

The present disclosure also provides a method for controlling cutting of hair by using the cleaning base station as described above, the method includes: determining that a cleaning device is placed in a predetermined area of the cleaning base station, and controlling starting of the cutting apparatus and rotation of the brush head of the cleaning device.

The present disclosure also provides a cleaning system, including: a cleaning device; and a cleaning base station. The cleaning device or the cleaning base station is provided with the cutting apparatus as described above.

In addition, the above-mentioned cutting apparatus of the present disclosure may further have the following additional features.

According to an embodiment of the present disclosure, the cutting apparatus further includes: the drive mechanism includes a rotary shaft and drive members arranged at intervals on the rotary shaft. The drive mechanism includes N+1, N, or N−1 drive members; when the drive mechanism includes N+1 drive members, one of the N+1 drive members is disposed between two adjacent movable blades and has two end surfaces opposite to each other, and the movable blade has a driven portion, and the end surface is in a linkage engagement with the driven portion to drive the reciprocation of the movable blade relative to the fixed blade between the first position and the second position, the at least two movable blades having movement directions opposite to each other; when the drive mechanism includes N drive members, each of the N drive members is in a linkage engagement with one of the N movable blades, and the N drive members are each obliquely disposed in a direction close to the rotary shaft; and when the drive mechanism includes N−1 drive members, one of the N−1 drive members is disposed between the two adjacent movable blades, and the end surface is in a linkage engagement with the driven portion to drive the reciprocation of the movable blade relative to the fixed blade between the first position and the second position, the at least two movable blades having movement directions opposite to each other, and the cutting apparatus further includes at least two elastic restoration members distributed in an axial direction of the rotary shaft, at least one of the at least two elastic restoration members being located between the housing and a first one of the N movable blades, and at least another one of the at least two elastic restoration members being located between the housing and a Nth one of the N movable blades.

According to an embodiment of the present disclosure, each of the N movable blades has driven portions opposite to each other in a length direction of the movable blade; at the first position, one of the driven portions of the movable blade is abutted against an end surface of the drive member adjacent to the one driven portion to be pushed towards the second position; at the second position, another one of the driven portions of the movable blade is abutted against an end surface of the drive member adjacent to the other driven portion to be pushed towards the first position.

According to an embodiment of the present disclosure, when the drive mechanism includes the N drive members, the N drive members each are asymmetrical drive members, and two adjacent of the N drive members have opposite inclination directions to drive the two adjacent movable blades to move in opposite directions.

According to an embodiment of the present disclosure, when the drive mechanism includes the N+1 or N−1 drive members, the N+1 or N−1 drive members are each symmetrical drive members, and the two adjacent movable blades have opposite movement directions.

According to an embodiment of the present disclosure, the end surface has a maximum axial length position point and a minimum axial length position point in the axial direction of the rotary shaft. The maximum axial length position point and the minimum axial length position point are respectively located at two opposite sides of the rotary shaft. For two adjacent drive members, the maximum axial length position point of one of the two adjacent drive members is opposite to the minimum axial length position point of another one of the adjacent two drive members.

According to an embodiment of the present disclosure, when the drive mechanism includes N+1 or N−1 drive members, some of the N+1 or N−1 drive members are symmetrical drive members, and some of the N+1 or N−1 drive members are asymmetrical drive members. Movable blades located at two sides of the symmetrical drive members have opposite movement directions, and movable blades located at two sides of the asymmetrical drive members have a same movement direction.

According to an embodiment of the present disclosure, the end surface has a maximum axial length position point and a minimum axial length position point in the axial direction of the rotary shaft. The maximum axial length position point and the minimum axial length position point are respectively located at two opposite sides of the rotary shaft. For two adjacent symmetrical drive members, the maximum axial length position point of one of the two adjacent drive members is opposite to the minimum axial length position point of another one of the two adjacent drive members. The asymmetrical drive member is obliquely disposed in the direction close to the rotary shaft, and two end surfaces of each of the symmetrical drive member and the asymmetrical drive member have a concave portion and a convex portion. The convex portion of the end surface of the symmetrical drive member and a concave portion of an end surface of an asymmetrical drive member adjacent to the symmetrical drive member are positioned in one-to-one correspondence. According to an embodiment of the present disclosure, the driven portion of the movable blade is in line contact with the end surface of the drive member.

According to an embodiment of the present disclosure, the end surface of the drive member is a smooth curved surface. The smooth curved surface of the symmetrical drive member is divided into a concave portion and a convex portion. A lowest position point of the concave portion is coincident with the minimum axial length position point, and a highest position point of the convex portion is coincident with the maximum axial length position point; and a concave portion of one of end surfaces of the asymmetrical drive member and a convex portion of another one of the end surfaces of the asymmetrical drive member are positioned in one-to-one correspondence, and a convex portion of one of end surfaces of the asymmetrical drive member and a concave portion of the other one of the end surfaces of the asymmetrical drive member are positioned in one-to-one correspondence.

According to an embodiment of the present disclosure, the end surface of the symmetrical drive member is an inclined plane, the maximum axial length position point and the minimum axial length position point are respectively located at a top end and a bottom end of the end surface, and the end surface of the asymmetrical drive member is an inclined plane.

According to an embodiment of the present disclosure, the cutting apparatus further includes N elastic pressing members each having an end fixed to the housing and another end fixed to a side of the movable blade away from the fixed blade to press and engage the fixed blade and the movable blade.

According to an embodiment of the present disclosure, the movable blade is slidably connected to the housing; or the movable blade is slidably connected to the fixed blade.

According to an embodiment of the present disclosure, the driven portion is a roller disposed on the movable blade, or the driven portion is a smooth flange on the movable blade.

According to an embodiment of the present disclosure, said determining that the cleaning device has completed the cleaning operation, and controlling the starting of the cutting apparatus includes: controlling the brush head to rotate in a same direction as the cleaning operation or an opposite direction to the cleaning operation; and controlling a fan of the cleaning device to start simultaneously during the control of the starting of the cutting apparatus.

According to an embodiment of the present disclosure, said controlling the rotation of the brush head of the cleaning device includes: controlling the brush head to rotate in a same direction as the cleaning operation or an opposite direction to the cleaning operation; and controlling a fan of the cleaning device to start simultaneously during the control of the starting of the cutting apparatus.

The present disclosure has the following beneficial effects.
1. The cutting apparatus of the present disclosure includes fixed blades and movable blades. Compared with an existing whole long cutter, in the present disclosure, the processing difficulty and cost are significantly lowered, and straightness and an engagement degree between the blades are guaranteed. In addition, the two adjacent movable blades have the opposite movement directions. In this way, an inertia force can be counteracted with each other, and vibration of the system is reduced.
2. By controlling operation of the cutting apparatus, the cleaning device, and the cleaning base station, an operation time of a cutting module can be decreased, extending its lifespan.
3. By providing the cutting apparatus on the cleaning base station instead of directly fixing the cutting apparatus to the cleaning device itself, the cleaning device has an original structure remaining unchanged without increasing its weight. Moreover, at this time, the cutting apparatus is used as an external accessory. Therefore, a user may flexibly select and use the cutting apparatus as their own requirements, making it easier for maintenance and replacement.

### BRIEF DESCRIPTION OF THE DRAWINGS

The accompanying drawings are used for a purpose of illustrating some embodiments only, rather than limiting the present disclosure. Moreover, throughout the accompanying drawings, same elements are denoted by same reference numerals. In the accompanying drawings:

In order to clearly explain the embodiments of the present disclosure or in the related art, accompanying drawings used in the description of the embodiments or the related art are briefly described below. The accompanying drawings as described below are merely some embodiments of the present disclosure.

FIG. 1 is a schematic structural diagram of a cutting apparatus according to an embodiment of the present disclosure.

FIG. 2 is an exploded view 1 of FIG. 1.

FIG. 3 is an exploded view 2 of FIG. 1.

FIG. 4 is a perspective view of a drive member in FIG. 1.

FIG. 5 is a side view of FIG. 4; and

FIG. 6 is a schematic structural diagram of a cutting apparatus according to another embodiment of the present disclosure.

FIG. 7 is a perspective view of a drive member in FIG. 6.

FIG. 8 is a side view of the drive member in FIG. 7.

FIG. 9 is an exploded view 1 of a cutting apparatus according to another embodiment of the present disclosure.

FIG. 10 is a combined state diagram of the cutting apparatus in FIG. 9.

FIG. 11 is a schematic structural diagram of a movable blade of FIG. 10.

FIG. 12 is a schematic structural diagram of a cutting apparatus according to another embodiment of the present disclosure.

FIG. 13 is a partial schematic structural diagram of a cutting apparatus according to another embodiment of the present disclosure.

FIG. 14 is a front view of FIG. 13.

FIG. 15 is a schematic structural diagram of a cutting apparatus according to another embodiment of the present disclosure.

FIG. 16 is an exploded view of a cutting apparatus according to another embodiment of the present disclosure.

FIG. 17 is a combined state diagram of the cutting apparatus in FIG. 16.

FIG. 18 is a schematic structural diagram of a cutting apparatus according to another embodiment of the present disclosure.

FIG. 19 is a schematic structural diagram of a cleaning device according to an embodiment of the present disclosure.

FIG. 20 is a partial perspective view of FIG. 19.

FIG. 21 is a perspective view of a brush head of FIG. 19.

FIG. 22 is an exploded view of FIG. 21.

FIG. 23 is a cross-sectional view of FIG. 19.

FIG. 24 is a schematic structural diagram of a cleaning base station according to an embodiment of the present disclosure.

FIG. 25 is a schematic structural diagram of a cleaning base station and a cleaning device used in combination according to an embodiment of the present disclosure.

FIG. 26 is a schematic structural diagram of a cleaning base station and a cleaning device used in combination according to another embodiment of the present disclosure.

FIG. 27 is a cross-sectional view of a cleaning base station and a cleaning device used in combination according to an embodiment of the present disclosure.

### DESCRIPTIONS OF REFERENCE NUMERALS

cutting apparatus 100, housing 11, opening 110, first housing 111, second housing 112, fixed blade 12, movable blade 13, driven portion 130, toothed edge 14, rotary shaft 15, drive member 16, end surface 160, drive motor 17, belt 18, belt pulley 19, bearing 20, elastic pressing member 21, elastic restoration member 22, cleaning device 200, casing 201, brush head 202, brush head rod 202a and wipe member 202b, cleaning base station 300, and base 30.

### DETAILED DESCRIPTION OF THE DISCLOSURE

Embodiments of the present disclosure will be described below in combination with accompanying drawings of the embodiments of the present disclosure. The embodiments described below are only a part, rather than all, of the embodiments of the present disclosure.

It should be noted that, when the embodiments of the present disclosure relate to directional indication (such as up, down, left, right, front, and back, etc.), the directional indication is only configured to explain a relative position relationship, a motion situation, etc. between components in a specific posture (as shown in the drawings). When the specific posture changes, the directional indication also changes accordingly.

In addition, when the embodiments of the present disclosure relate to terms such as “first” and “second”, the terms such as “first” and “second” are used herein for purposes of description and are not intended to indicate or imply relative importance or significance, or implicitly indicate the number of indicated features. Therefore, the feature associated with “first” and “second” may include one or more this feature distinctly or implicitly. In the description of the present disclosure, “plurality of” means at least two, unless otherwise specifically indicated.

In the present disclosure, unless otherwise clearly specified and limited, terms such as “connect”, “connect to”, “fix”, and the like should be understood in a broad sense. For example, “fix” may be a fixed connection or a detachable connection or connection as one piece; mechanical connection or electrical connection; direct connection or indirect connection through an intermediate; internal communication of two components or the interaction relationship between two components.

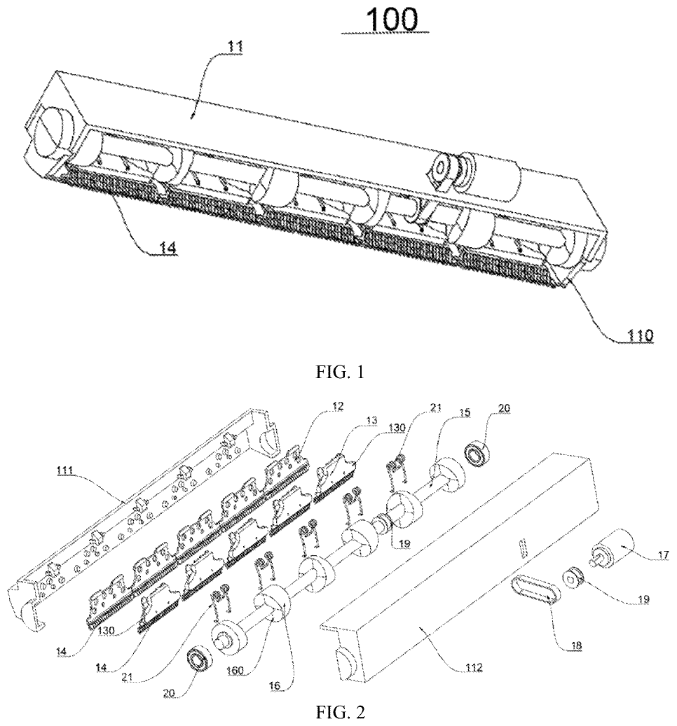

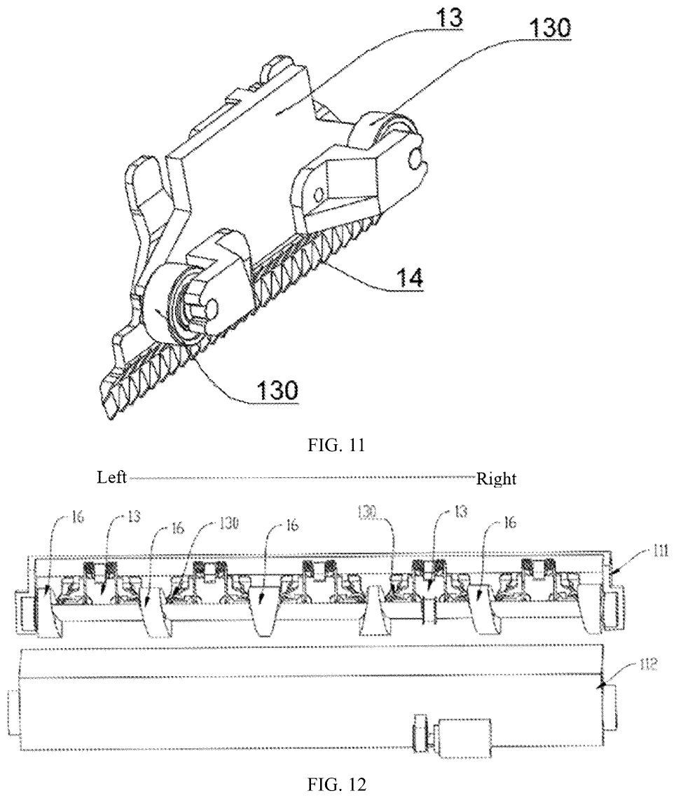

The cutting apparatus 100 according to some embodiments of the present disclosure is described below with reference to FIG. 1 to FIG. 18. The cutting apparatus 100 may be used to cut elongated fibrous rubbish such as hair tangled on a roller brush of a cleaning device.

As illustrated in FIG. 1 to FIG. 18, according to embodiments of the present disclosure, provided is a cutting apparatus 100, including a housing 11 having an opening 110, N groups of blades and a drive mechanism. The N groups of blades are located in the housing and are linearly arranged. The N groups of blades each include a fixed blade 12 and a movable blade 13, where N is a positive integer greater than or equal to 2. N fixed blades 12 and N movable blades 13 are each linearly arranged and are located in the housing 11. Each of the N movable blades 13 corresponds to one of the N fixed blades 12. Each of the N fixed blades 12 and each of the N movable blades 13 have a toothed edge 14 protruding from the opening 110 towards an outer side of the housing 11, and the toothed edge 14 of the fixed blade 12 is tightly fitted to the toothed edge 14 of the movable blade 13. The drive mechanism is in a linkage engagement with the movable blade 13 and configured to drive a reciprocation of the movable blade 13 relative to the fixed blade 12 between a first position and a second position. At least two movable blades 13 have movement directions opposite to each other. In this embodiment, during the reciprocation of the movable blade 13 relative to the fixed blade 12, the toothed edge 14 of the fixed blade 12 and the toothed edge 14 of the movable blade 13 are interleaved relative to each other to perform cutting movement, to achieving cutting of hair wound on the roller brush.

In addition, during a movement of the N movable blades 13, the movement directions of the at least two movable blades 13 are opposite.

In this way, an inertia force may be counteracted with each other between the at least two movable blades 13 with opposite movement directions, to decrease vibration of the system.

Next, in this embodiment, the cutting apparatus 100 is described in detail by taking N=5 as an example in combination with the accompanying drawings. In one embodiment, N may also be 2, 3, 4, 6, etc. The present disclosure is not limited herein, and may flexibly select a value of N as needed.

In this embodiment, the housing 11 includes a first housing 111 and a second housing 112 in abutting joint with the first housing 111. An accommodation chamber having an opening 110 is defined by enclosing the first housing 111 and the second housing 112 together. The fixed blade 12 and the movable blade 13 and all or part of the drive mechanism are located in the accommodation chamber.

Further, the drive mechanism includes a rotary shaft 15 and drive members 16 arranged at intervals on the rotary shaft 15. The drive mechanism includes N+1, N, or N−1 drive members 16. It can be understood that different numbers of the drive members 16 correspond to different embodiments. Next, each embodiment is described in detail according to the number of drive members 16.

In an embodiment of the present disclosure, with continued reference to FIG. 1 to FIG. 6, there are N+1 drive members 16, i.e., there are six drive members 16 and five movable blades 13. The five movable blades 13 are each located at a side of the rotary shaft 15. One movable blade 13 is disposed between two adjacent drive members 16. The drive member 16 has two end surfaces 160 opposite to each other. Each of the N movable blades 13 has two driven portions 130 opposite to each other in a length direction of the movable blade 13, and the end surface 160 is in a linkage engagement with the driven portion 130. In some embodiments, at the first position, one of the driven portions 130 of the movable blade 13 is abutted against an end surface 160 of the drive member 16 adjacent to the one driven portion to be pushed towards the second position; at the second position, another one of the driven portions 130 of the movable blade 13 is abutted against an end surface 160 of the drive member 16 adjacent to the other driven portion to be pushed towards the first position. That is, the drive member 16 is in contact with the driven portion 130 of the movable blade 13 through the end surface 160 to drive the movable blade 13. Moreover, each of the movable blades 13 may be driven by the drive members 16 adjacent to the movable blade to perform cutting motion whether the movable blade 13 is at the first position or the second position.

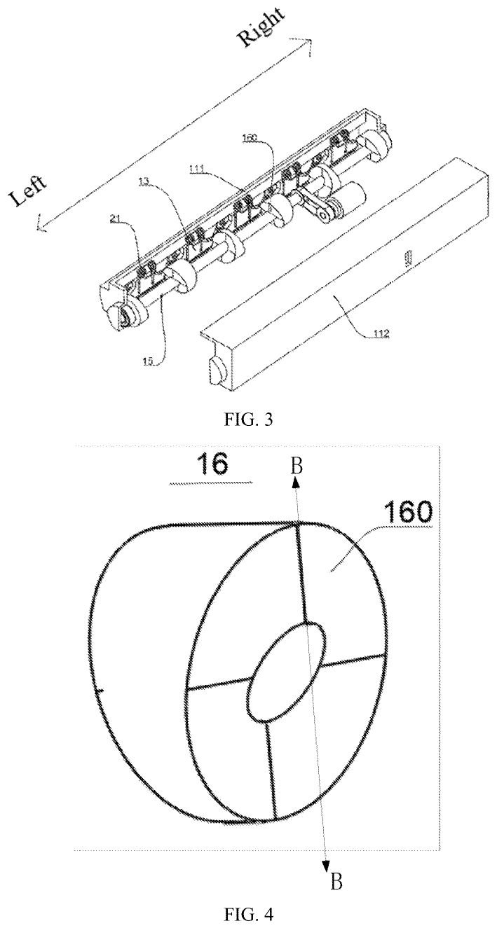

With continued reference to FIG. 3 and FIG. 6, for ease of description, the first position may be defined as a left side, the second position is defined as a right side. In a leftward-to-rightward direction, the five movable blades 13 may be defined as a first movable blade, a second movable blade, a third movable blade, and the like, respectively. Correspondingly, the six drive members 16 are defined as a first drive member, a second drive member, a third drive member, and the like, respectively. Please refer to the accompanying drawings for specific details.

In an embodiment of the present disclosure, with continued reference to FIG. 3 to FIG. 5, in an axial direction perpendicular to the rotary shaft 15, each drive member 16 is a symmetrical drive member, and movement directions of the two adjacent movable blades 13 are opposite. It should be noted that the “symmetrical drive member” in this embodiment refers to that the drive member 16 is symmetrical along a symmetry plane A-A perpendicular to the axial direction of the rotary shaft 15. It can be understood that when the movement directions of the two adjacent movable blades 13 are opposite, an inertia force may be counteracted with each other between the first movable blade and the second movable blade, and an inertia force may be counteracted with each other between the third movable blade and the fourth movable blade. At this time, the vibration brought to the system by the movable blade 13 can be minimized.

In some embodiments, as illustrated in FIG. 3 to FIG. 5, the drive member 16 may be in a cam-like shape. The end surface 160 has a maximum axial length position point and a minimum axial length position point in the axial direction of the rotary shaft 15. The maximum axial length position point and the minimum axial length position point are respectively located at two opposite sides of the rotary shaft 15. For two adjacent drive members 16, the maximum axial length position point of one of the two adjacent drive members 16 is opposite to the minimum axial length position point of another one of the two adjacent drive members 16, i.e., the drive member 16 has a great axial length end and a small axial length end. It should be noted that the terms “great axial length end” and “small axial length end” are used relative to each other.

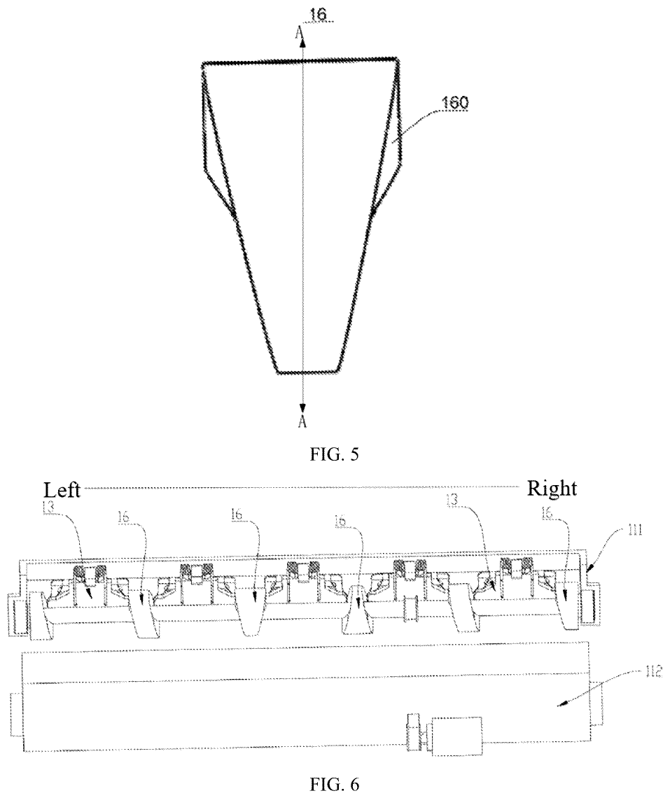

It should be noted that, with continued reference to FIG. 4 and FIG. 5, the drive member 16 in this embodiment is symmetrical along A-A of FIG. 5 except for along the B-B in FIG. 4. The two end surfaces 160 are respectively divided into a front part surface and a rear part surface by the B-B, and a connecting line of any two opposite points on an upper front part surface or the rear part surface of each of the two end surfaces 160 have a length gradually decreasing from top to bottom.

Since the adjacent drive member 16 has the same driving principle for the movable blade 13, in this embodiment, only the driving principle of the first movable blade is described in detail. A great axial length end of the first drive member is opposite to a small axial length end of the second drive member. Conversely, a small axial length end of the first drive member is opposite to a great axial length end of the second drive member. In this way, in this embodiment, the second drive member abuts against a driven portion of the first movable blade by means of the great axial length end, to drive the first movable blade to move towards the left side (i.e., in a direction close to the small axial length end of the first drive member).

In this process, the first drive member and the second drive member rotate along with the rotary shaft 15. When the first drive member rotates to the great axial length end, the second drive member rotates to the small axial length end. At this time, the first drive member abuts against another driven portion of the first movable blade, to drive the first movable blade to move towards the right side (i.e., in a direction close to the small axial length end of the second drive member). This reciprocating motion achieves the cutting motion of the first movable blade.

In another embodiment of the present disclosure, when the five movable blades 13 move simultaneously, only some of the adjacent movable blades 13 have opposite movement directions, and the movement directions of other adjacent movable blades 13 are the same. In order to achieve a movement of the movable blade 13 in the same or opposite direction, as illustrated in FIG. 6 to FIG. 8, some of the six drive members 16 may be symmetrical drive members, and the rest of the six drive members 16 are asymmetrical drive members 16 in a flattened shape. Movable blades 13 located at each of two sides of the symmetrical drive members 16 have opposite movement directions, and movable blades 13 located at each of two sides of the asymmetrical drive members 16 have a same movement direction. In some embodiments, the first movable blade and the second movable blade move leftwards, the third movable blade moves rightwards, the fourth movable blade moves leftwards, and the fifth movable blade moves leftwards. Correspondingly, the first drive member, the third drive member, the fourth drive member, and the sixth drive member are symmetrical drive members, and the second drive member and the fifth drive member are asymmetrical drive members. It should be noted that for the first drive member and the sixth drive member, as their outer side end surface does not need to drive the movable blade 13, the outer side end surfaces of the first drive member and the sixth drive member may be slightly different from those of other symmetrical drive member structures.

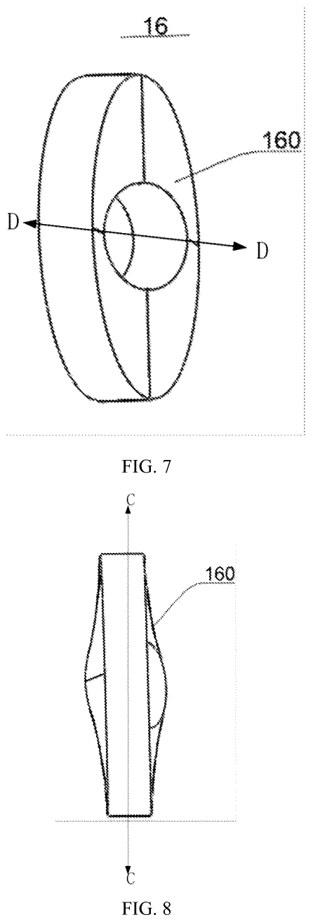

It should be noted that, further as illustrated in FIG. 7, the asymmetrical drive member in this embodiment only refers to that the drive member is asymmetrical along a symmetric plane D-D perpendicular to the axial direction of the rotary shaft 15. However, the asymmetrical drive member may also be symmetrical along C-C of FIG. 8. The two end surfaces 160 are respectively divided into an upper portion surface and a lower portion surface by the D-D, and lengths of connecting lines between any two opposite points on the upper portion surface or the lower portion surface of the two end surfaces 160 may be equal. In addition, the structure of the symmetrical drive member in this embodiment is the same as a structure of the drive member in FIG. 3 to FIG. 5. The asymmetrical drive member 16 is inclined in the direction close to the rotary shaft 15. Two end surfaces 160 of each of the symmetrical drive member and the asymmetrical drive member have a concave portion and a convex portion. The convex portion of the end surface 160 of the symmetrical drive member and a concave portion of an end surface 160 of an asymmetrical drive member adjacent to the symmetrical drive member are positioned in one-to-one correspondence. Further referring to FIG. 6 to FIG. 8, the second drive member and the fifth drive member are disposed obliquely towards the left. A concave portion of an end surface 160 of the first drive member and a convex portion of an end surface 160 of the second drive member are positioned in one-to-one correspondence. A concave portion of another end surface 160 of the second drive member and a convex portion of an end surface 160 of the third drive member are positioned in one-to-one correspondence. A convex portion of another end surface 160 of the third drive member and a concave portion of an end surface 160 of the fourth drive member are positioned in one-to-one correspondence. A concave portion of another end surface 160 of the fourth drive member and a convex portion of an end surface 160 of the fifth drive member are positioned in one-to-one correspondence. A concave portion of another end surface 160 of the fifth drive member and a convex portion of an end surface 160 of the sixth drive member are positioned in one-to-one correspondence.

In one embodiment, a number and arrangement manner of the symmetrical drive member and the asymmetrical drive member are not limited thereto, as long as opposite movement directions of the at least two movable blades can be realized within the protection scope of the present disclosure. Further, further referring to FIG. 2, the drive mechanism in this embodiment further includes a drive motor 17, a belt 18, and two belt pulleys 19. The belt 18 is sleeved on the belt pulley 19. One of the two belt pulleys 19 is fixedly sleeved on the rotary shaft 15, and another one of the two belt pulleys 19 is connected to a rotary shaft of the drive motor 17. The belt 18 passes through the second housing 112 and is sleeved on the belt pulley 19 on the rotary shaft 15. The drive motor 17 is located at an outer side of the housing 11. In addition, two opposite tail ends of the rotary shaft 15 are each provided with a bearing 20, which can reduce a friction force when the rotary shaft 15 rotates.

It should be noted that, when the driven portion 130 of the movable blade 13 abuts against the end surface 160 of the drive member 16, line contact or point contact may be formed between the driven portion 130 of the movable blade 13 and the end surface 160 of the drive member 16. It should be noted that, in the present disclosure, the line contact refers to contact between the driven portion 130 and the end surface 160 being a continuous line, while the point contact here refers to the contact between the driven portion 130 and the end surface 160 being always one or more points.

In the above embodiments, with continued reference to FIGS. 4 and 5 and FIGS. 7 and 8, when the driven portion 130 of the movable blade 13 forms line contact with the end surface 160 of the drive member 16, the end surface 160 of the symmetrical drive member may be a smooth curved surface that is divided into a concave portion and a convex portion. The lowest position point of the concave portion is coincident with the minimum axial length position point, and the highest position point of the convex portion is coincident with the maximum axial length position point. A concave portion of one of end surfaces 160 of the asymmetrical drive member and a convex portion of another one of the end surfaces 160 of the asymmetrical drive member are positioned in one-to-one correspondence, and a convex portion of one of end surfaces 160 of the asymmetrical drive member and a concave portion of the other one of the end surfaces of the asymmetrical drive member 160 are positioned in one-to-one correspondence. In some embodiments, the drive member 16 drives the movable blade 13 to reciprocate by means of a concave-convex smooth curved surface on the end surface 160. It should be noted that, in this case, under the driving of the drive member 16, each movable blade 13 has a motion trajectory in an arc shape. Since the movable blade 13 has a motion component in its arrangement direction, the movable blade 13 can still form an interleaved cutting motion with the fixed blade 12.

In an embodiment of the present disclosure, when the driven portion 130 of the movable blade 13 forms point contact with the end surface 160 of the drive member 16, the end surface 160 of the asymmetrical drive member is an inclined plane, and the end surface 160 of the symmetrical drive member may be an inclined plane. Moreover, the maximum axial length position point and the minimum axial length position point of the end surface 160 are respectively located at a top end and a bottom end of the end surface 160. At this time, the drive member 16 has a cross section in a shape of an isosceles trapezoid and an axial length gradually decreasing from the top end of the drive member 16 to the bottom end of the drive member 16. It should be noted that, in this case, each movable blade 13, driven by the drive member 16, has a linear motion trajectory.

Further, in this embodiment, with continued reference to FIG. 2 and FIG. 3, the cutting apparatus 100 further includes N elastic pressing members 21 each having one end fixed to the first housing 111 and another end fixed to a side of the movable blade 13 away from the fixed blade 12 to press and engage the fixed blade 12 and the movable blade 13. In some embodiments, the elastic pressing member 21 may be a spring member. Under the action of the elastic pressing member 21, the toothed edge 14 of the fixed blade 12 is tightly fitted to the toothed edge 14 of the movable blade 13 to achieve interleaved cutting motion between the movable blade 13 and the fixed blade 12. In addition, because of the close engagement between the toothed edge 14 of the fixed blade 12 and the toothed edge 14 of the movable blade 13, it is also possible to prevent the hair from being flicked into a gap between the fixed blade 12 and the movable blade 13 during cutting, improving efficiency of cutting hair.

In some embodiments of the present disclosure, each movable blade 13 may be slidably connected to the housing 11; or each movable blade 13 is slidably connected to a corresponding fixed blade 12. In a further embodiment, when driven by the drive member 16, the movable blade 13 may linearly slide along the housing 11 or the fixed blade 12, which can improve stability of the movement of the movable blade 13.

In this embodiment, as illustrated in FIG. 2, the driven portion 130 may be a smooth flange on the movable blade 13.

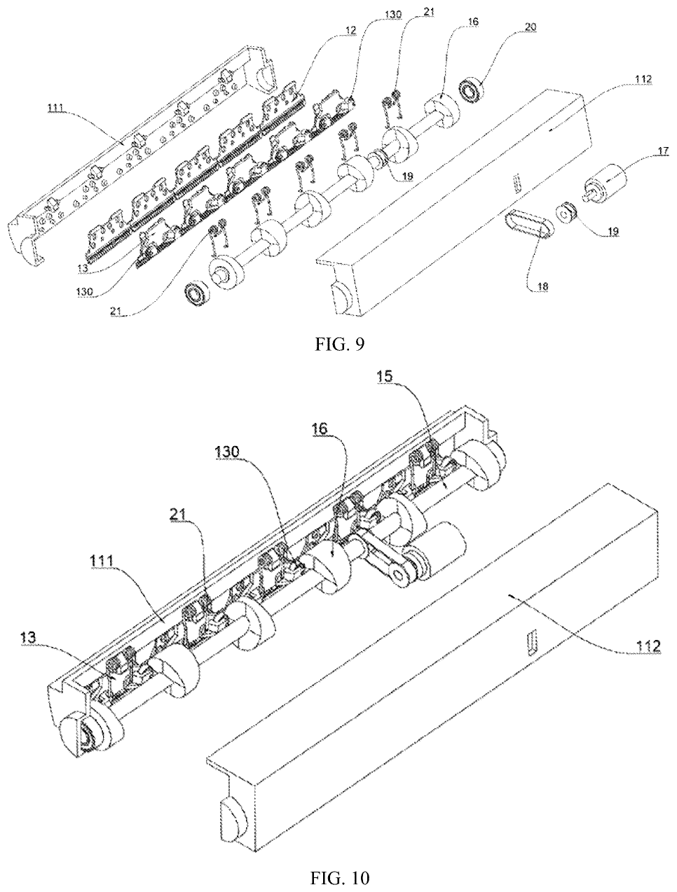

In some embodiments of the present disclosure, as illustrated in FIG. 9 to FIG. 12, the driven portion 130 may further be a roller disposed on the movable blade 13. In a further embodiment, the end surface 160 of the drive member 16 is in contact with the roller, allowing the movement of the movable blade 13 to be driven by the roller, which can decrease the friction force when the drive member 16 drives the movable blade 13.

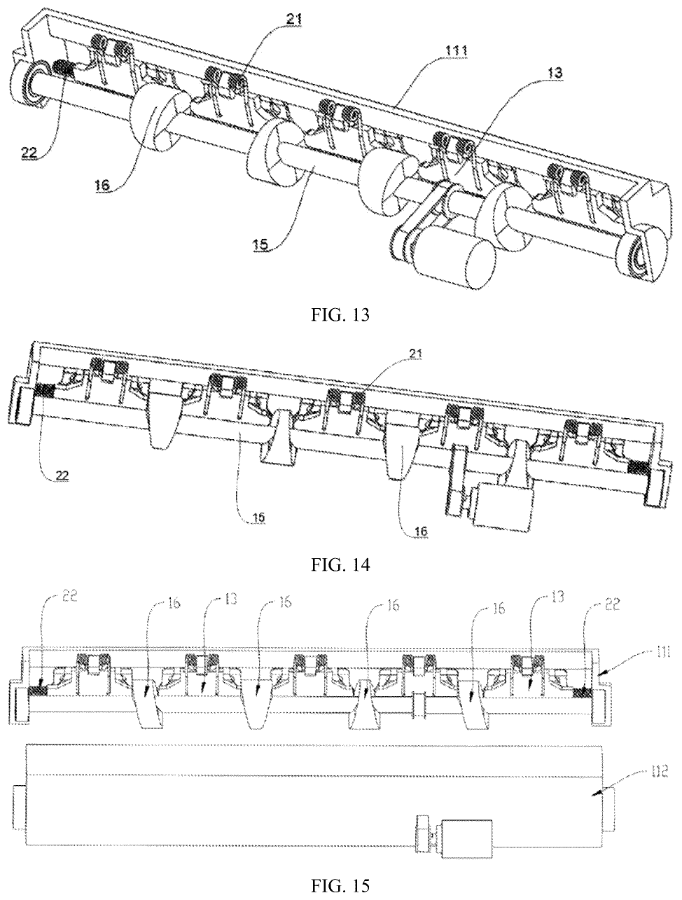

In another embodiment of the present disclosure, as illustrated in FIG. 13 to FIG. 15, when the drive mechanism includes N−1 drive members 16, i.e., provided are four drive members 16. Moreover, one of the four drive members 16 is provided between the two adjacent movable blades 13. At this time, the drive mechanism further includes at least two elastic restoration members 22 distributed in an axial direction of the rotary shaft 15. At least one of the at least two elastic restoration members 22 is located between the housing 11 and a first one of the N movable blades, and at least another one of the at least two elastic restoration members 22 is located between the housing 11 and a Nth one of the N movable blades 13. In this embodiment, the drive mechanism further includes two elastic restoration members 22. One of the two elastic restoration members 22 is located between the first movable blade and the housing 11, and another one of the two elastic restoration members 22 is located between the fifth movable blade and the housing 11. In a further embodiment, the elastic restoration members 22 each applies a force towards a middle of the cutting apparatus on the first movable blade and the fifth movable blade at both ends of the cutting apparatus, allowing the first movable blade and the fifth movable blade to respectively abut against their respective contactable drive members 16. Therefore, a purpose of driving the two movable blades by using one drive member 16 is realized.

Similarly, in some embodiments of the present disclosure, the movement directions of two adjacent movable blades 13 may be opposite to each other. In this case, the drive members are symmetrical drive members. It can be understood that further referring to FIG. 15, among the five movable blades 13, some adjacent movable blades 13 have opposite movement directions, while others have the same movement directions. Accordingly, some of the drive members 16 are symmetrical drive members, and some of the drive members 16 are asymmetrical drive members. The movable blades 13 located at two sides of the symmetrical drive members 16 have opposite movement directions, and the movable blades 13 located at two sides of the asymmetrical drive members 16 have a same movement direction. It is worth mentioning that the structure of symmetrical drive member and the asymmetrical drive member 16 and the principle of driving the movable blade 13 in this embodiment are the same as those in FIG. 12, and details are not described herein.

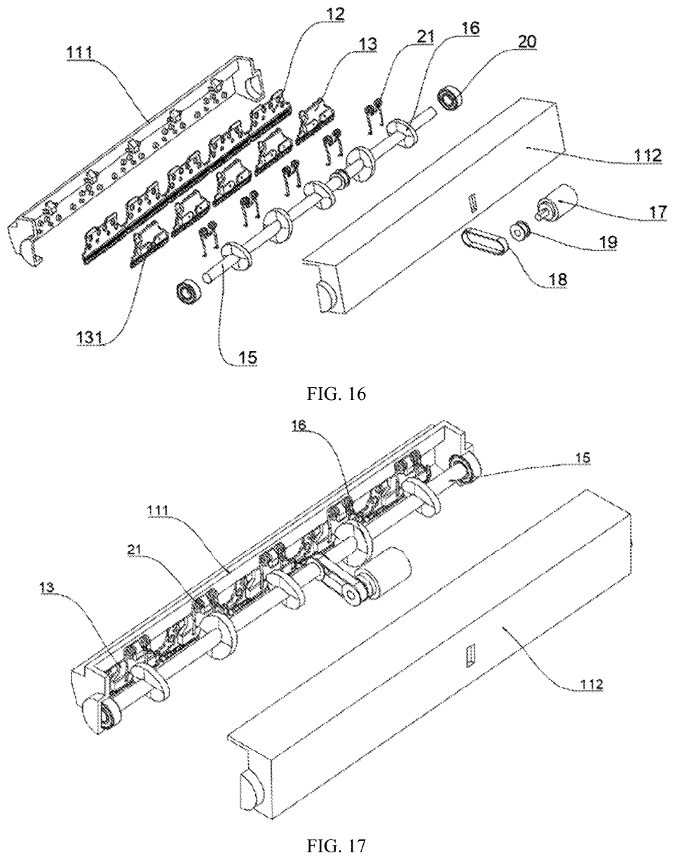

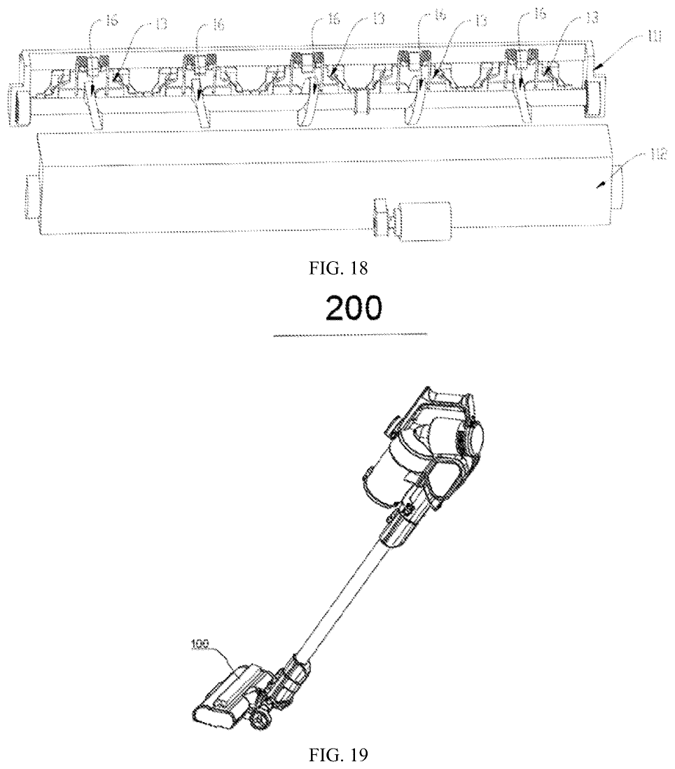

In another embodiment of the present disclosure, as illustrated in FIG. 16 and FIG. 18, provided are N drive members 16, i.e., provided are five drive members 16 each in a linkage engagement with one movable blade 13. At this time, the movable blade 13 has a connection end 131 connected to the drive member 16. The N drive members 16 are obliquely disposed on the rotary shaft 15 and each obliquely disposed in a direction close to the rotary shaft 15. Moreover, the two adjacent drive members 16 have opposite inclination directions. In some embodiments, each drive member 16 drives one movable blade 13 to move, with the first drive member inclining towards the left side, the second drive member inclining towards the right side, and so on for inclination directions of the rest of the drive members. It should be noted that the structure of the drive member 16 in this embodiment is the same as the structure of the asymmetrical drive member as illustrated in FIG. 6 to FIG. 8 with only slight differences in thickness. In addition, the driving principle of the drive member 16 for the movable blade 13 in the embodiment is the same as shown in FIG. 6 to FIG. 8. Therefore, further elaboration on this embodiment is not necessary here.

Further, the connection end 131 may be a roller disposed on the movable blade 13 or a smooth flange on the movable blade 13. In some embodiments, the end surface 160 of the drive member 16 is in contact with the roller, to drive the movable blade 13 to move through the roller, which can reduce the friction force when the drive member 16 drives the movable blade 13.

Similarly, in another embodiment of the present disclosure, as illustrated in FIG. 18, when each drive member 16 drives only one movable blade 13 to move, some adjacent movable blades 13 move in opposite directions, while others move in the same direction. At this time, for the five drive members 16, some of the drive members 16 have the same inclination direction, and some of the drive members 16 have opposite inclination directions. In some embodiments, the first drive member, the second drive member, and the fifth drive member are each inclined towards the left, and the third drive member and the fourth drive member are both inclined towards the right. In this way, the first movable blade, the second movable blade, and the fifth movable blade each move leftwards, and the third movable blade and the fourth movable blade both move rightwards. Therefore, cancellation of the inertia force is achieved, and the vibration of the system is greatly lowered.

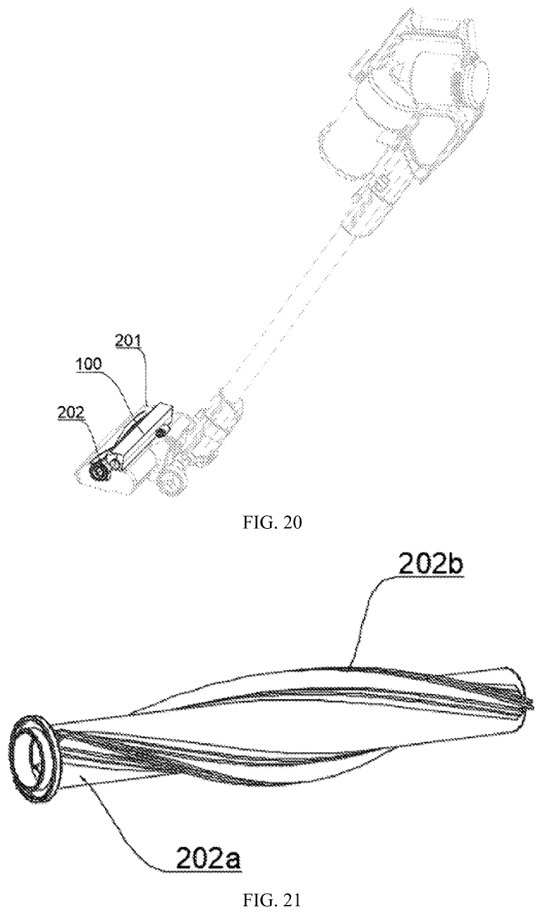

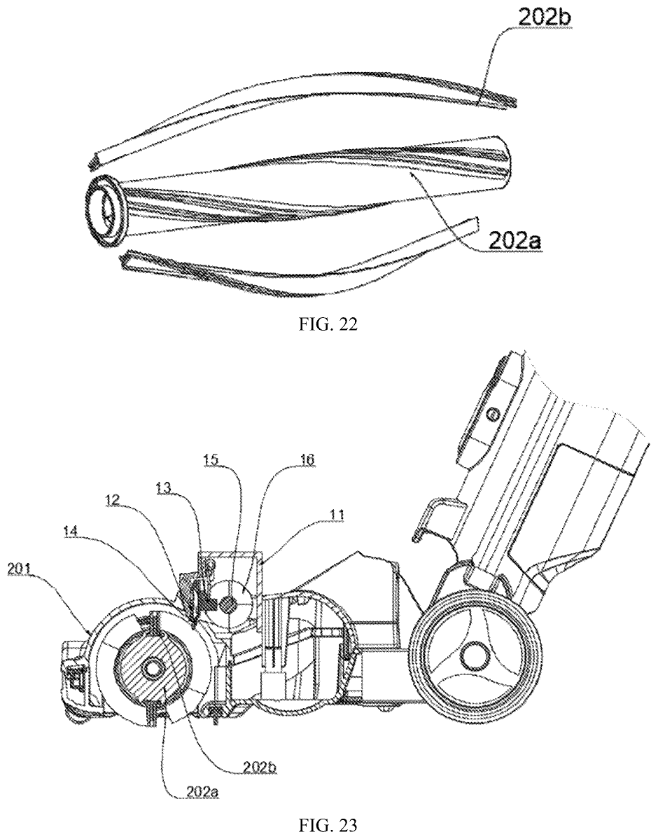

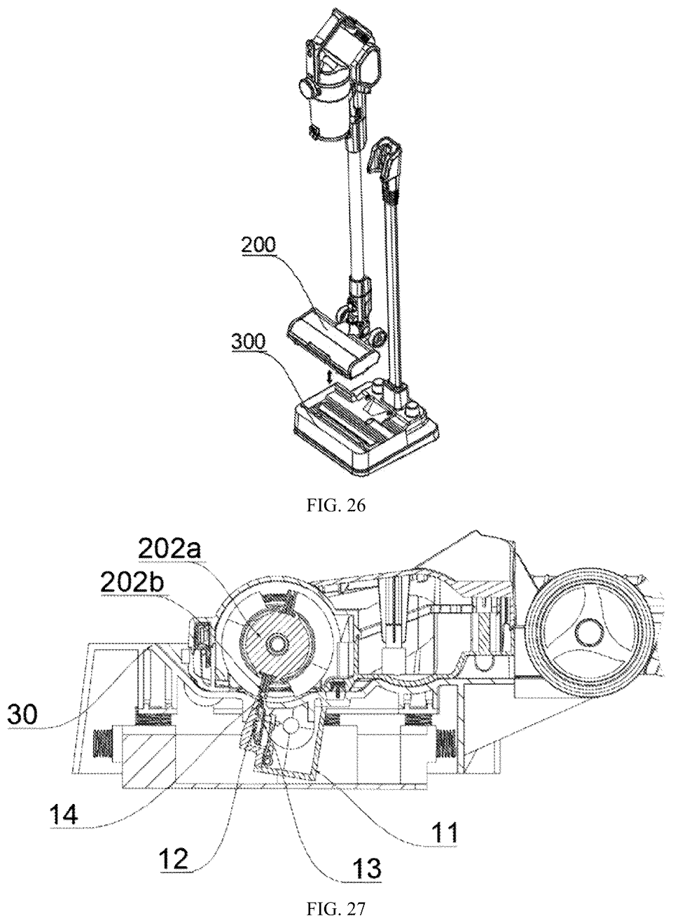

It should be noted that the number of the drive members 16 and the arrangement manner of the drive member 16 are not limited in the present disclosure. Other arrangements can also be used as long as they achieve that a case of the at least two movable blades moving in opposite directions falls within the protection scope of the present disclosure. As illustrated in FIG. 19 to FIG. 27, an embodiment of the present disclosure further provides a cleaning device 200. The cleaning device 200 may be a handheld floor scrubber, a mopping robot, or a sweeping robot. The cleaning device 200 includes a casing 201, a brush head 202, and the cutting apparatus 100. The toothed edge 14 of the fixed blade 12 or the toothed edge 14 of the movable blade 13 is in contact with an outer peripheral surface of the brush head 202.

Here, the brush head 202 includes a brush head rod 202a and a wipe member 202b. The brush head rod 202a is of a substantially cylindrical shape having a rotation axis. The wipe member 202b is made of soft material and is disposed at a cylindrical sidewall of the brush head rod 202a for contacting a surface to be cleaned and performing wiping and cleaning. When the cleaning device 200 is in operation, the brush head 202 rotates around the rotation axis of the brush head rod 202a to drive the wipe member 202b thereon to rotate. During the rotation, the wipe member 202b is in contact with the surface to be cleaned, which achieves a wiping and cleaning effect.

During rotation of the brush head 202, only one of the toothed edge 14 of the fixed blade 12 or the toothed edge 14 of the movable blade 13 will be in contact with the wipe member 202b, while the other will not be in contact with the wipe member 202b. In some embodiments, the benefit of ensuring that only one blade's toothed edge 14 is in contact with the wipe member 202b is to prevent the wipe member 202b from being in contact with a region where a cutting edge of the movable blade 13 and a cutting edge of the fixed blade 12 perform overlapped and interleaved movement and being cut.

When the brush head 202 rotates to clean the surface, it is possible for long fibers such as hair from the cleaned surface to get tangled on the brush head 202, affecting a cleaning effect of the brush head 202 on the ground. Moreover, removing the tangled hair from the brush head 202 may be cumbersome for the user. However, when equipped with the cutting apparatus, a relative movement between the toothed edge 14 of the fixed blade 12 and the toothed edge 14 of the movable blade 13 can cut off the tangled hair from the brush head 202.

Further, in this embodiment, a method for controlling cutting of hair by using the cleaning device 200 may include: determining that the cleaning device 200 is performing a cleaning operation, and controlling starting of the cutting apparatus 100.

In some embodiments, when the cleaning device 200 is performing a surface cleaning operation, the cutting apparatus 100 is controlled to start all the time. In this state, the cutting apparatus 100 may perform real-time cutting on the hair on the brush head 202, preventing excessive hair from getting tangled on the brush head 202 and affecting the surface cleaning performance.

In other embodiments of the present disclosure, it is also possible to control the cutting apparatus 100 to start intermittently when the cleaning device 200 is determined to perform the cleaning operation. In some embodiments, when the cleaning apparatus 200 is performing the surface cleaning operation, the cutting apparatus 100 may be started intermittently, for example, starting every 2 or 5 minutes.

In other embodiments of the present disclosure, it is also possible to control the starting of the cutting apparatus 100 when determining that the cleaning device 200 has completed the cleaning operation. In some embodiments, during the surface cleaning operation of the cleaning device 200, the cutting apparatus 100 does not start. After the cleaning device 200 has completed the cleaning operation, the cutting apparatus 100 starts to cut the hair tangled on the brush head 202.

Further, the operation of determining that the cleaning device 200 has completed the cleaning operation, and controlling the starting of the cutting apparatus includes: controlling the brush head 200 to rotate in a same direction as the cleaning operation or an opposite direction to the cleaning operation. In some embodiments, the hair, tightly wound in one rotation direction of the brush head 202, will temporarily loosen when the brush head 202 rotates in an opposite direction, which is beneficial to be cut by the toothed edge 14.

Further, the operation of controlling the starting of the cutting apparatus 100 further includes: controlling a fan of the cleaning device 200 to start simultaneously during the control of the starting of the cutting apparatus. In some embodiments, when the cutting apparatus 100 starts for cutting, a suction source/fan of the cleaning device 200 is controlled to start to suck away hair that has been cut off from the brush head 202, ensuring the uncut hair be in contact with the cutter. Therefore, the cutting effect is enhanced.

It should be noted that the cleaning device 200 is provided with a control button for independently controlling whether the cutting apparatus 100 starts. A user operating the cleaning device 200 freely determines whether to start or close the cutting apparatus 100. In addition, it is also possible to remotely control the starting of the cutting apparatus 100, which is not limited in the present disclosure.

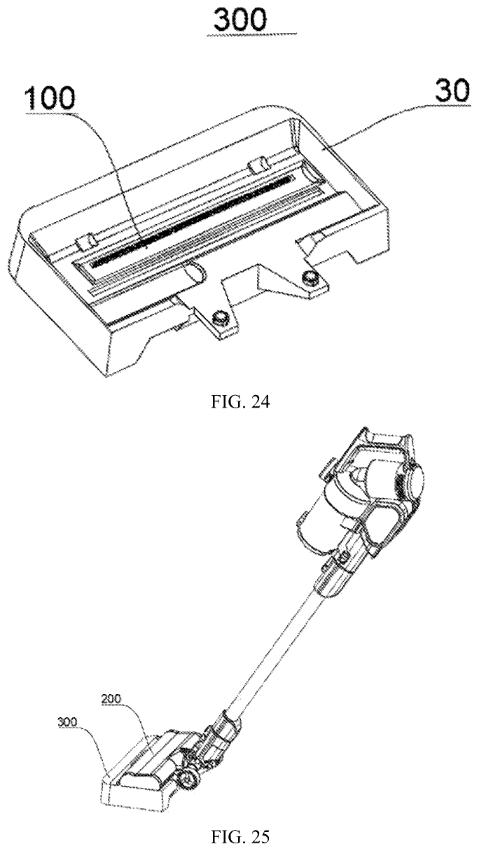

As illustrated in FIG. 24 to FIG. 27, an embodiment of the present disclosure further provides a cleaning base station 300. The cleaning base station 300 may be used for cleaning elongated fibrous debris such as hair entangled on the brush head 202 of the cleaning device 200. In one embodiment, the cleaning base station 300 may also be integrated into the cleaning device 200 to perform charging, water replenishing, and other functions. The embodiment does not limit this. The cleaning base station 300 includes a base 30 and the cutting apparatus 100 as described above. The cutting apparatus 100 is mounted on the base 30. The toothed edge 14 of the fixed blade 12 or the toothed edge 14 of the movable blade 13 is in contact with the outer peripheral surface of the brush head 202.

In this embodiment, the cleaning device 200 includes a casing 201 and a brush head 202. The toothed edge 14 of the fixed blade 12 or the toothed edge 14 of the movable blade 13 is in contact with an outer peripheral surface of the brush head 202.

Here, the brush head 202 includes a brush head rod 202a and a wipe member 202b. The brush head rod 202a is of a substantially cylindrical shape having a rotation axis. The wipe member 202b is made of soft material and is disposed at a cylindrical sidewall of the brush head rod 202a for contacting a surface to be cleaned and performing wiping and cleaning. When the cleaning device 200 is in operation, the brush head 202 rotates around the rotation axis of the brush head rod 202a to drive the wipe member 202b thereon to rotate. During the rotation, the wipe member 202b will be in contact with the surface to be cleaned, which achieves a wiping and cleaning effect.

The cutting apparatus 100 in this embodiment is not fixed together with the cleaning device 200 itself. The cutting apparatus 100 does not require any modifications to the original structure of the cleaning device 200, nor does it add any additional weight. Instead, the cutting apparatus 100 is used as an external accessory, which can be flexibly selected and used by the user according to their own requirements, and also facilitates maintenance and replacement.

In this embodiment, the cleaning device 200 is a handheld vacuum cleaner, which generally further includes a push rod. The push rod is rotatably connected to the casing 201. The cleaning base station 300 further includes a storage bracket vertically connected to the base 30. The storage bracket has an engagement portion. The push rod is engaged with the engagement portion of the storage bracket.

Further, in this embodiment, the method for controlling the cutting of hair by using the cleaning base station 300 may include: determining that a cleaning device 200 is placed in a predetermined area of the cleaning base station 300, and controlling starting of the cutting apparatus 100 and rotation of the brush head 202 of the cleaning device 200.

Further, the operation of controlling the rotation of the brush head 202 of the cleaning device 200 includes: controlling the brush head 202 to rotate in a same direction as the cleaning operation or an opposite direction to the cleaning operation. In some embodiments, the hair, tightly wound in one rotation direction of the brush head 202, will temporarily loosen when the brush head 202 rotates in an opposite direction, which is beneficial to be cut by the toothed edge 14.

Further, the operation of controlling the starting of the cutting apparatus 100 further includes: controlling a fan of the cleaning device 200 to start simultaneously during the control of the starting of the cutting apparatus. In some embodiments, when the cutting apparatus 100 starts for cutting, the suction source/fan of the cleaning device 200 is controlled to start to suck away the hair that has been cut off from the brush head 202, ensuring the uncut hair to be in contact with the cutter. Therefore, the cutting effect is improved.

The embodiments of the present disclosure further provide a cleaning system, including the cleaning device 200 and the cleaning base station 300. The cleaning device 200 or the cleaning base station 300 is provided with the cutting apparatus 100 as described above.

The embodiments as described above are merely embodiments of the present disclosure, and is not therefore intended to limit the scope of the present disclosure. Any equivalent structural modification made based on the specification and the accompanying drawings of the present disclosure, or directly/indirectly application to other related art, are all included within the scope of the present disclosure.

1. A cutting apparatus, comprising:
a housing having an opening;
N groups of blades each comprising a fixed blade and a movable blade, wherein:
N fixed blades are located in the housing and arranged linearly, where N is a positive integer greater than or equal to 2; and
N movable blades are located in the housing and arranged linearly, each of the N movable blades corresponding to one of the N fixed blades, each of the N fixed blades and each of the N movable blades having a toothed edge protruding from the opening towards an outer side of the housing, and the toothed edge of the fixed blade being tightly fitted to the toothed edge of the movable blade; and
a drive mechanism in a linkage engagement with the movable blade and configured to drive a reciprocation of the movable blade relative to the fixed blade between a first position and a second position, at least two movable blades having movement directions opposite to each other.

2. The cutting apparatus according to claim 1, wherein the drive mechanism comprises a rotary shaft and a plurality of drive members arranged at intervals on the rotary shaft, wherein:
the drive mechanism comprises N+1, N, or N−1 drive members;
when the drive mechanism comprises N+1 drive members, one of the N+1 drive members is disposed between two adjacent movable blades and has two end surfaces opposite to each other, wherein the movable blade has a driven portion, and the end surface is in a linkage engagement with the driven portion to drive the reciprocation of the movable blade relative to the fixed blade between the first position and the second position, the at least two movable blades having movement directions opposite to each other;
when the drive mechanism comprises N drive members, each of the N drive members is in a linkage engagement with one of the N movable blades, wherein the N drive members are each obliquely disposed in a direction close to the rotary shaft; and
when the drive mechanism comprises N−1 drive members, one of the N−1 drive members is disposed between the two adjacent movable blades, wherein the end surface is in a linkage engagement with the driven portion to drive the reciprocation of the movable blade relative to the fixed blade between the first position and the second position, the at least two movable blades having movement directions opposite to each other, and wherein the cutting apparatus further comprises at least two elastic restoration members distributed in an axial direction of the rotary shaft, at least one of the at least two elastic restoration members being located between the housing and a first one of the N movable blades, and at least another one of the at least two elastic restoration members being located between the housing and a Nth one of the N movable blades.

3. The cutting apparatus according to claim 2, wherein:
each of the N movable blades has driven portions opposite to each other in a length direction of the movable blade;
at the first position, one of the driven portions of the movable blade is abutted against an end surface of the drive member adjacent to the one driven portion to be pushed towards the second position; and
at the second position, another one of the driven portions of the movable blade is abutted against an end surface of the drive member adjacent to the other driven portion to be pushed towards the first position.

4. The cutting apparatus according to claim 2, wherein when the drive mechanism comprises the N drive members, the N drive members each are asymmetrical drive members, and two adjacent of the N drive members have opposite inclination directions to drive the two adjacent movable blades to move in opposite directions.

5. The cutting apparatus according to claim 2, wherein when the drive mechanism comprises the N+1 or N−1 drive members, the N+1 or N−1 drive members are each symmetrical drive members, and the two adjacent movable blades have opposite movement directions, and
wherein the end surface has a maximum axial length position point and a minimum axial length position point in the axial direction of the rotary shaft, the maximum axial length position point and the minimum axial length position point being respectively located at two opposite sides of the rotary shaft, wherein for two adjacent drive members, the maximum axial length position point of one of the two adjacent drive members is opposite to the minimum axial length position point of another one of the two adjacent drive members.

6. (canceled)

7. The cutting apparatus according to claim 2, wherein when the drive mechanism comprises N+1 or N−1 drive members, some of the N+1 or N−1 drive members are symmetrical drive members, and some of the N+1 or N−1 drive members are asymmetrical drive members, wherein movable blades located at two sides of the symmetrical drive members have opposite movement directions, and movable blades located at two sides of the asymmetrical drive members have a same movement direction.

8. The cutting apparatus according to claim 7, wherein the end surface has a maximum axial length position point and a minimum axial length position point in the axial direction of the rotary shaft, the maximum axial length position point and the minimum axial length position point being respectively located at two opposite sides of the rotary shaft, wherein:
for two adjacent symmetrical drive members, the maximum axial length position point of one of the two adjacent drive members is opposite to the minimum axial length position point of another one of the two adjacent drive members;
the asymmetrical drive member is obliquely disposed in the direction close to the rotary shaft; and
two end surfaces of each of the symmetrical drive member and the asymmetrical drive member have a concave portion and a convex portion, wherein the convex portion of the end surface of the symmetrical drive member and a concave portion of an end surface of an asymmetrical drive member adjacent to the symmetrical drive member are positioned in one-to-one correspondence.

9. The cutting apparatus according to claim 4, wherein the driven portion of the movable blade is in line contact with the end surface of the drive member.

10. The cutting apparatus according to claim 8, wherein the end surface of the drive member is a smooth curved surface, wherein the smooth curved surface of the symmetrical drive member is divided into a concave portion and a convex portion, wherein:
a lowest position point of the concave portion is coincident with the minimum axial length position point, and a highest position point of the convex portion is coincident with the maximum axial length position point; and
a concave portion of one of end surfaces of the asymmetrical drive member and a convex portion of another one of the end surfaces of the asymmetrical drive member are positioned in one-to-one correspondence, and a convex portion of a first of end surfaces of the asymmetrical drive member and a concave portion of a second of the end surfaces of the asymmetrical drive member are positioned in one-to-one correspondence.

11. The cutting apparatus according to claim 8, wherein:
the end surface of the symmetrical drive member is an inclined plane;
the maximum axial length position point and the minimum axial length position point are respectively located at a top end and a bottom end of the end surface; and
the end surface of the asymmetrical drive member is an inclined plane.

12. The cutting apparatus according to claim 1, further comprising:
N elastic pressing members each having an end fixed to the housing and another end fixed to a side of the movable blade away from the fixed blade to press and engage the fixed blade and the movable blade.

13. The cutting apparatus according to claim 11, wherein:
the movable blade is slidably connected to the housing; or
the movable blade is slidably connected to the fixed blade.

14. The cutting apparatus according to claim 2, wherein:
the driven portion is a roller disposed on the movable blade, or
the driven portion is a smooth flange on the movable blade.

15. A cleaning device, comprising:
a casing;
a brush head; and
the cutting apparatus according to claim 14, wherein the toothed edge of the fixed blade or the toothed edge of the movable blade is in contact with an outer peripheral surface of the brush head.

16. A method for controlling cutting of hair by using the cleaning device according to claim 15, the method comprising:
determining that the cleaning device is performing a cleaning operation, and controlling starting of the cutting apparatus; or
determining that the cleaning device is performing the cleaning operation, and controlling the cutting apparatus to start intermittently; or
determining that the cleaning device has completed the cleaning operation, and controlling the starting of the cutting apparatus.

17. The method according to claim 16, wherein said determining that the cleaning device has completed the cleaning operation, and controlling the starting of the cutting apparatus comprises:
controlling the brush head to rotate in a same direction as the cleaning operation or an opposite direction to the cleaning operation; and
controlling a fan of the cleaning device to start simultaneously during the control of the starting of the cutting apparatus.

18. A cleaning base station, comprising:
a base; and
the cutting apparatus according to claim 14, the cutting apparatus is mounted on the base,
wherein the toothed edge of the fixed blade or the toothed edge of the movable blade is in contact with an outer peripheral surface of a brush head.

19. A method for controlling cutting of hair by using the cleaning base station according to claim 18, the method comprising:
determining that a cleaning device is placed in a predetermined area of the cleaning base station, and controlling starting of the cutting apparatus and rotation of the brush head of the cleaning device.

20. The method according to claim 19, wherein said controlling the rotation of the brush head of the cleaning device comprises:
controlling the brush head to rotate in a same direction as the cleaning operation or an opposite direction to the cleaning operation; and
controlling a fan of the cleaning device to start simultaneously during the control of the starting of the cutting apparatus.

21. A cleaning system, comprising:
a cleaning device; and
a cleaning base station, the cleaning device or the cleaning base station being provided with a cutting apparatus, comprising:
a housing having an opening;
N groups of blades each comprising a fixed blade and a movable blade, wherein:
N fixed blades are located in the housing and arranged linearly, where N is a positive integer greater than or equal to 2; and
N movable blades are located in the housing and arranged linearly, each of the N movable blades corresponding to one of the N fixed blades, each of the N fixed blades and each of the N movable blades having a toothed edge protruding from the opening towards an outer side of the housing, and the toothed edge of the fixed blade being tightly fitted to the toothed edge of the movable blade; and
a drive mechanism in a linkage engagement with the movable blade and configured to drive a reciprocation of the movable blade relative to the fixed blade between a first position and a second position, at least two movable blades having movement directions opposite to each other.
